(19) United States
(12) Patent Application Publication
(10) Pub. No.: US 2026/0071661 A1
(43) Pub. Date: Mar. 12, 2026

(54) COMPOSITE MATERIAL BRAKE PAD AND ITS MANUFACTURING METHOD

(71) Applicant: ITT Italia S.R.L., Milan (IT)

(72) Inventors: Alberto CONTE, Barge (IT); Agustin SIN XICOLA, Barge (IT); Ugo BUSSO, Barge (IT); Valter MARTINO, Barge (IT)

(73) Assignee: ITT Italia S.R.L., Milan (IT)

(21) Appl. No.: 19/162,889

(22) PCT Filed: Mar. 5, 2024
(86) PCT No.: PCT/IB2024/052104

§ 371 Date: Sep. 5, 2025

(30) Foreign Application Priority Data
Mar. 6, 2023 (IT) 102023000004047

(51) Int. Cl. F16D 65/092; B29C 43/00; B29C 43/18; B29C 43/20; B29C 70/08; B29C 70/34; B29L 31/00; F16D 69/02; F16D 69/04

(52) U.S. Cl. CPC F16D 65/092; B29C 43/006; B29C 43/18; B29C 43/203; B29C 70/081; B29C 70/345; F16D 69/023; B29L 2031/7482; F16D 2069/0483; F16D 2069/0491

(57) ABSTRACT

A brake pad (1), in particular for electric or hybrid vehicles, including a support consisting of a backplate (2) and a friction material block (3) attached to the backplate; the backplate (2) consists of a substrate (12) made of a fiber reinforced SMC/BMC (Sheet/Bulk Molding Compound) and of a reinforcing metal core (14) completely embedded in the substrate (12) and extending crosswise thereof between first sides thereof (6,7) provided with guiding portions (10,11), which are mechanically connected to each other through the substrate (12) by the reinforcing metal core (14); the fiber reinforced SMC/BMC consisting of chopped long strand fibers chosen among carbon fibers, glass fibers, mixtures thereof dispersed in a pre-cured thermosetting polymer chosen in the group consisting of vinyl ester resins, phenolic based resins and epoxy resins added with a flame retardant. A co-molding method for forming the brake pad (1) is also disclosed.

### CROSS-REFERENCE TO RELATED APPLICATIONS

This Patent application claims priority from Italian Patent Application No. 102023000004047 filed on Mar. 6, 2023, the entire disclosure of which is incorporated herein by reference.

### TECHNICAL FIELD

The present invention relates to a brake pad made of a composite material and combining lightweight, robustness and reliability, adapted, particularly but not exclusively, to equip electric vehicles.

The invention also relates to an associated manufacturing method to produce such a brake pad in a simple and effective manner.

### STATE OF THE ART

Brake pads for combustion engine vehicles are generally produced combining a support with a block of friction material configured to cooperate with an element to be braked (e.g., a brake disc) and which is molded or glued onto the support. The support is usually shaped like a plate, so as it is also known as “the backplate”.

The support or backplate is made of a steel or anyway in a metal, e.g., it may be made in a light alloy or aluminum, in order to give sufficient stiffness and robustness to the brake pad during the braking.

In electric and hybrid car, lower pressure and stress are generated during braking. For these types of applications composite reinforced backplates have been proposed, since lower thermal and mechanical performances are required.

For instance, organic resins can be used as the base material for obtaining a backplate, owing to the presence in the vehicle of the regenerative braking, that decreases the operating temperatures and stress acting on the brake pad.

The use of composite materials for backplate production also appears to be advantageous, since permits to eliminate the painting operation in the production cycle of the brake pad, owing to the intrinsic corrosion resistance of organic composites, when compared to steel.

U.S. Pat. No. 10,414,883B2 in the name of Sumitomo discloses a method for producing a plastic reinforced article, in particular consisting in a backplate for a brake pad, and a brake pad including such backplate. Commercial products based on such technology have also been proposed on the market.

However, such brake pad products are not completely satisfying, since their manufacture and application need the brake pad shape to be completely re-designed and, accordingly, the caliper structure is to be re-designed too. In particular, in order to avoid mechanical stress concentration in critical parts of the backplate, the latter is to be shaped as a substantially rectangular plate of regular shape, what has strongly limited up to now the diffusion of reinforced plastic backplates.

### SUMMARY OF THE INVENTION

The object of the present invention is to provide a brake pad, particularly but not exclusively adapted for electric or hybrid vehicles, having a backplate thereof made of a composite material, as well as to provide an associate backplate, overcoming the disadvantages of the prior art, in particular by providing a backplate combining lightweight, robustness and reliability and that can be molded/designed without any shape limitation.

It is a further object of the invention to provide a method for manufacturing such a brake pad and associated backplate, which is simple and economic to be carried out, and which ensures shorter and simpler production cycles.

The invention is therefore related to a brake element consisting in a brake pad and to an associated backplate and a manufacturing method, as defined in the appended claims.

The invention also relates to a braking system comprising at least a brake element and at least a brake disc cooperating therewith as also defined in the appended claims.

The present disclosure demonstrates how it is possible to obtain a brake pad having a backplate made of a composite material which is lightweight and is at the same time sufficiently stiff and robust to fully replace the traditional backplate made of a metal, like steel or a light alloy, both on traditional vehicles and, above all, on electric or hybrid vehicle.

In some embodiments, the brake pad has a backplate comprising: a substrate shaped like a flat plate and provided with a first face, a second face opposite and substantially parallel to the first face, and a perimetral edge bounding the first and second face, the substrate having the outer shape of the finished backplate and being made of a fiber reinforced SMC (Sheet Molding Compound) or BMC (Bulk Molding Compound); and a reinforcing metal core completely embedded in the substrate and extending crosswise between first sides thereof defining corresponding opposite first lateral sides of the backplate and provided with guiding portions designed to engage in use, in known manner, known guiding and supporting means of a vehicle caliper.

The metal core has opposite flat ends completely embedded in the guiding portions, so that these latter are mechanically connected to each other through the substrate by the reinforcing metal core, and by the substrate itself.

In preferred embodiments, the sheet material forming the substrate may be an SMC (Sheet Molding Compound) and more generally may be chosen in the group consisting of vinyl ester SMC, phenolic based SMC/BMC and epoxy SMC, preferably added with any flame retardant commonly used in the art. Here and in the following, when only SMC is indicated for sake of simplicity, it is to be intended anyway that, also due to their chemical similarities, a BMC too may be used as a possible alternative.

In all the above preferred embodiments, the SMC (Sheet Molding Compound) or BMC forming the substrate consists of a pre-cured polymer matrix in which chopped long strand mineral fibers are embedded.

Here and in the following for “long strands” is intended strands of mineral fibers having a length comprised between 50 and 100 mm.

In preferred embodiments, the mineral fibers are chosen in the group consisting of carbon fibers, glass fibers, mixtures thereof.

In some embodiments, the pre-cured polymeric matrix is added with mineral fillers.

As mineral fillers, inorganic fillers commonly used in friction material compositions may be used, such as barite (barium sulfate), calcium carbonate, talc, magnesium oxide, vermiculite, mica, others having physical and/or chemical properties comparable therewith.

In some preferred embodiments, the reinforcing metal core is made of steel and consists in an elongated metal bar extending within the guiding portions provided on opposite first lateral sides of the backplate and within the substrate, parallel to the first and second face thereof.

In some preferred embodiments, the metal bar forming the metal core is straight and has a substantially rectangular cross-section.

In some preferred embodiments, the guiding portions consist of a first and a second ear, opposite to each other and extending cantilever from first opposite lateral sides of the backplate in directions opposite to each other and substantially parallel to second opposite sides of the backplate extending transversally the first sides.

In preferred embodiments, the metal bar has opposite flat ends, each embedded within one of the first and second ear for the majority of the width thereof, measured perpendicular to the second opposite sides of the backplate.

It has been surprisingly found, in fact, that SMC formed by specifically selected pre-cured thermosetting polymer plastic resins constituting the matrix of the SMC/BMC and within which mineral fibers are evenly dispersed may be fully cured, making them stiffer, under substantially the same temperatures and pressures used in the art for molding the blocks of friction materials of the known brake pads from the commonly used raw friction material compositions also well known in the art.

It has been found, also, that, preferably, the mineral fibers are to be carefully selected too, and in function of the chemical nature of the pre-cured thermosetting polymer plastic resins constituting the matrix of the SMC.

In preferred embodiments, SMC including long strands of carbon and/or glass fibers, which have been chopped shorter before incorporation in the polymer matrix are used.

In most preferred embodiments, accordingly, the substrate is formed either by vinyl ester-based SMC containing about 60% by weight of (chopped) long carbon fibers or by epoxy-based SMC containing about 55% by weight of (chopped) long carbon fibers or about 60% by weight of (chopped) long glass fibers.

The above mentioned “long strands” of mineral fibers are chopped to obtain shorter stands of a length comprised between 12 and 50 mm.

In preferred embodiments, multiple SMC/BMC sheets of the same composition, or even of different composition if anyway chemically compatible, may be used stacked one upon the other, to form a multi-layer blank formed by the superimposed SMC/BMC sheets and by the metal core which is sandwiched between at least two opposite SMC/BMC sheets.

Such a multi-layer blank may be directly formed, layer by layer, outside a mold provided with a cavity shaped so as to reproduce in negative the shape of the composite backplate to be obtained. Then, it is introduced in the cavity of the mold, the mold is closed, and pressure and heat are simultaneously applied to the multi-layer blank to bring the SMC/BMC sheets to a prefixed temperature and under a prefixed pressure designed to make them to be fully cured, so as to join integral in one piece to one another the stacked SMC/BMC sheets to form a composite substrate within which the metal (steel) bar is completely embedded.

In some preferred embodiments, a multi-layer blank may be formed by SMC/BMC sheets having at least two different perimetral profiles, e.g., by four SMC sheets, a first and a second SMC sheets being of identical shape, having been cut in the shape of a perimetral profile of the backplate to be produced. The different perimetral profiles among the composite sheets could be a possibly advantageous design approach, but its possible exploitation depends on the caliper and backplate geometry.

According to an important aspect of the invention, anyway, each first and second SMC sheet comprises respective first and second opposite transversal peripheral portions configured to obtain respective guiding portions of the when the corresponding first and second backplate transversal peripheral portions of the first and second SMC sheets are stacked onto each other.

In some preferred embodiment, a third and a fourth sheet of a SMC forming the multi-layer blank, are also cut in the shape of the perimetral profile of the backplate to be produced but without the first and second opposite transversal peripheral portions, which are therefore present on the first and second SMC sheets only.

The metal core consisting in a steel bar may be arranged sandwiched between the third and fourth SMC sheets with its flat opposite ends projecting cantilever outside the sheets in perimeter profile of the third and fourth SMC opposite directions.

The third and fourth SMC sheets are then sandwiched between the first and second SMC sheets. These two latter, however, are provided with the aforementioned first and second opposite transversal peripheral portions, which project cantilever and in opposite direction from the rest of the perimeter profile of the first and second SMC sheet themselves. Since these opposite transversal peripheral portions of the first and second SMC sheets are configured to have the same perimeter profile of the two opposite flat ends of the metal (steel) bar and to be slightly larger of the same, the flat ends of the metal (steel) bar remain sandwiched between the corresponding transversal peripheral portions of the first and second SMC sheets.

It has been surprisingly found that such a geometry gives rise to a composite backplate having guiding portions able to endure high mechanical stresses, comparable to those the metal backplates of the prior art are used to endure, since such mechanical stresses are distributed by the metal core in the whole substrate.

In any case, only the first and second SMC sheets and the metal core (the steel bar) are strictly necessary to fulfil the aim of the present invention, even if the further presence of the third and fourth SMC sheets (and eventually of more), either having or not having the same perimeter profile of the first and second composite sheets, is preferred, since it gives rise to a better mechanical behavior, the mechanical stresses being distributed through a ticker substrate.

In preferred embodiments, the curing of the first and the second SMC sheet (as well as of the third and fourth ones, when present) may be carried out at a temperature comprised between about 50° C. and 130° C., and under a pressure comprised between 10 and 20 MPa, for a time of the order of about 1 minute for each 0.5 mm of thickness of the backplate to be obtained.

In some preferred embodiments, the multi-layer blank may be formed before the molding operation for joining the SMC/BMC sheets together by arranging the first, second and third, fourth SMC sheets and the metal bar stacked one upon the other, according to the following sequence:
the first SMC sheet;
the third SMC sheet applied directly upon the first one but leaving free the transversal peripheral portions thereof;
the metal bar stacked on the third SMC sheet and with the opposite flat ends of the metal bar resting upon the transversal peripheral portions of the first SMC sheet;
the fourth SMC sheet, in direct contact with the metal bar and with the third SMC sheet in a whole area thereof not occupied by the metal bar;
the second SMC sheet stacked on the fourth SMC sheet in direct contact thereof and with its transversal peripheral portions stacked on the corresponding transversal peripheral portions of the first SMC sheet with the opposite flat ends of the metal bar sandwiched between corresponding transversal peripheral portions of the first and second SMC sheet.

The so obtained multi-layer blank is then placed inside a suitable mold for the curing/molding step.

In most preferred embodiments, the whole brake pad according to the invention is obtained together with its composite backplate by co-molding the composite backplate and the friction material block together.

This may be obtained using a mold having a cavity comprising an upper portion, having in negative the shape of the backplate and a bottom portion having in negative the shape of the friction material block.

A raw friction material composition of any known formulation is firstly introduced in the bottom portion of the mold cavity; then the pre-formed multi-layer blank (SMC/BMC sheets and metal bar) is arranged upon the raw friction material composition and in direct contact thereto, in the upper portion of the mold cavity. Thereafter, a single curing operation is carried out using the same pressure and temperature necessary to cure the SMC sheets, obtaining the formation within the mold of a finished brake pad having the friction material block and the composite backplate already attached integral together.

In this co-molding step, it may be arranged within the mold, between the multi-layer blank and the raw friction material composition, a layer of a material able to form, during the single curing and co-molding operation, a dampening and/or insulating layer known as the UL (underlayer), which is normally present in brake pads. This UL material can be either or not inserted in the same mold (so non forming an UL layer), owing to the greater elasticity of the final composite backplate (support for the friction material block) compared to steel. Of course, this will depend on the noise and elasticity required for the final brake pad.

### BRIEF DESCRIPTION OF THE DRAWINGS

Further features and advantages of the disclosed subject matter, whether explicitly mentioned or not, will become apparent in view of the disclosure provided below, with reference to the attached drawings, in which:

FIG. 1 shows schematically a braking element consisting of a possible and non-limiting embodiment of a brake pad according to the present invention;

FIG. 2 shows schematically a backplate according to a possible and non-limiting embodiment of the present invention and configured for obtaining the brake pad of FIG. 1;

FIG. 3A shows in a schematic and non-limiting manner the sequential steps of a manufacturing method according to the invention and designed to obtain the backplate of FIG. 2;

FIG. 3B shows in a schematic and non-limiting manner the sequential steps of a manufacturing method according to the invention and designed to obtain the brake pad schematically shown in FIG. 1;

FIG. 4 shows schematically and in a purely pictorial and non-limiting way a molding sequence according to a non-limiting embodiment of the method of the invention, the molding sequence being designed to obtain the brake pad schematically shown in FIG. 1;

FIG. 5 shows schematically and in a purely pictorial and non-limiting way a perspective exploded view, taken three quarter from the above, of a preferred embodiment of the backplate according to the invention;

FIG. 6 illustrates schematically in a purely pictorial and non-limiting way a perspective view, taken three quarter from the above, of some component elements of the backplate according to the invention partially assembled together;

FIG. 7 is a picture showing an assembly step of the backplate according to the invention;

FIG. 8 is a picture showing a top and a bottom view of a brake pad produced according to the method of the invention; and

FIG. 9 is a picture showing a cross-sectioned view of the brake pad of FIG. 8.

### DETAILED DESCRIPTION

In more detail, and with reference to FIGS. from 1 to 6, reference number 1 indicates a braking element consisting of a brake pad for vehicles, preferably but not exclusively configured to equip electric vehicles.

The brake pad 1 comprises a plate support 2, also commonly known as “backplate” and a friction material block 3 provided integral onto a first face 4 of the backplate 2.

The first face 4 is bounded by a perimetral edge 5 of the backplate.

The perimetral edge 5 is delimited by first opposite lateral sides 6, 7 thereof, and by second opposite longitudinal side 8,9 thereof, the first sides 6,7 being arranged transversely to the second sides 8,9.

The backplate 2 is made, as it will be seen, of a composite material and is provided with guiding portions 10,11 arranged respectively at the opposite first sides 6,7 of the backplate 2.

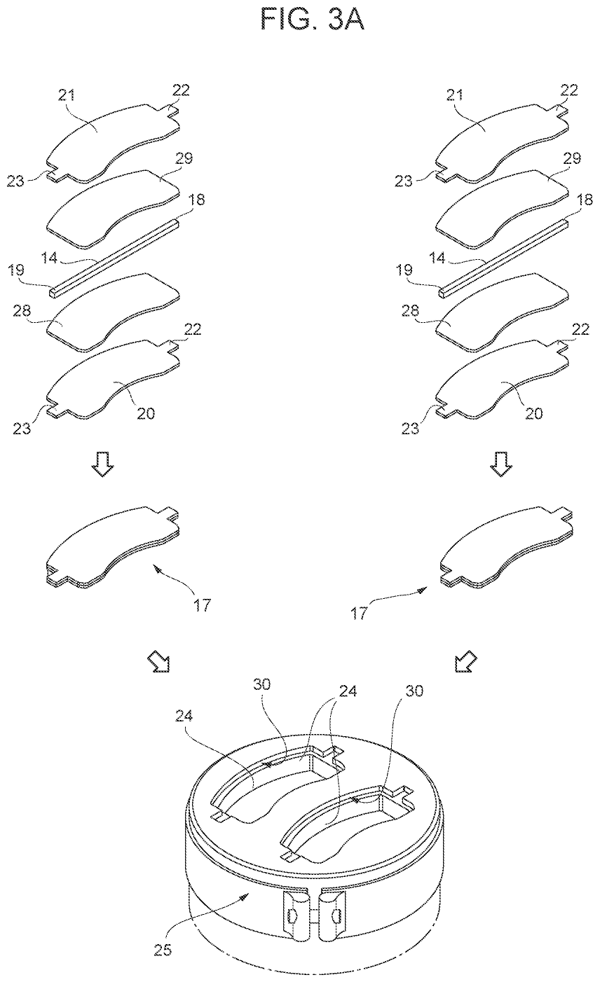

According to one aspect of the invention, the composite material forming the backplate 2 comprises/consist of:
a substrate 12 including the first face 4, the perimetral edge 5 and a second face 13, opposite and substantially parallel to the first face 4, the substrate 12 being made of a fiber reinforced SMC (Sheet Molding Compound) or BMC (Bulk Molding Compound); and
a reinforcing metal core 14 completely embedded in the substrate 12 and extending crosswise thereof between the first sides 6, 7 and within the guiding portions 10, 11 (see FIG. 2), so that the guiding portions 10, 11 of the opposite first sides 6, 7 are mechanically connected to each other through the substrate 12 by the reinforcing metal core 14 as well as by the substrate 12 itself.

According to a further aspect of the invention, the SMC/BMC (Sheet/Bulk Molding Compound) forming the substrate 12 is chosen in the group consisting of: vinyl ester SMC, phenolic based SMC/BMC and epoxy SMC, the latter preferably added with a flame retardant, since epoxy resins are highly inflammable.

Non-limiting and not exhaustive examples of flame retardant of possible use for incorporation in the epoxy resin-based SMC are: Ammonium Polyphosphate, 9,10-dihydro-9-oxa-10-phosphaphenanthrene-10-oxide (DOPO) and its derivatives, including triazine, phenethyl, diphosphonate, silsesquioxane, and bismaleimide, particles, preferably nanoparticles, of titania, zinc oxide, carbon fillers, and phosphates.

The SMCs (Sheet Molding Compounds) mentioned above and used in the present invention consist of a polymer matrix in which chopped long strand fibers are embedded, said fibers being chosen in the group consisting of: carbon fibers, glass fibers, mixtures thereof. The BMCs may have substantially the same fibers embedded, but in a different polymer matrix.

Here and below, for “long strand” is intended a strand of fibers having a length comprised between 50 and 100 mm.

According to one aspect of the invention, such “long strands” are chopped to obtain shorter stands of a length comprised between 12 and 50 mm.

The polymer matrix is preferably added with mineral fillers.

Non-limiting and not exhaustive examples of mineral fillers are: barite (barium sulfate), calcium carbonate, talc, magnesium oxide, vermiculite, mica.

Preferably, the reinforcing metal core 14 is made of steel and consists in an elongated metal (steel) bar extending within the guiding portions 10, 11 of the opposite first sides 6, 7 and within the substrate 12, parallel to both the first and second faces 4, 13, which are, preferably, substantially planar.

The metal (steel) bar 14 is preferably straight and may have, preferably but not exclusively, a substantially rectangular cross-section (see FIG. 6).

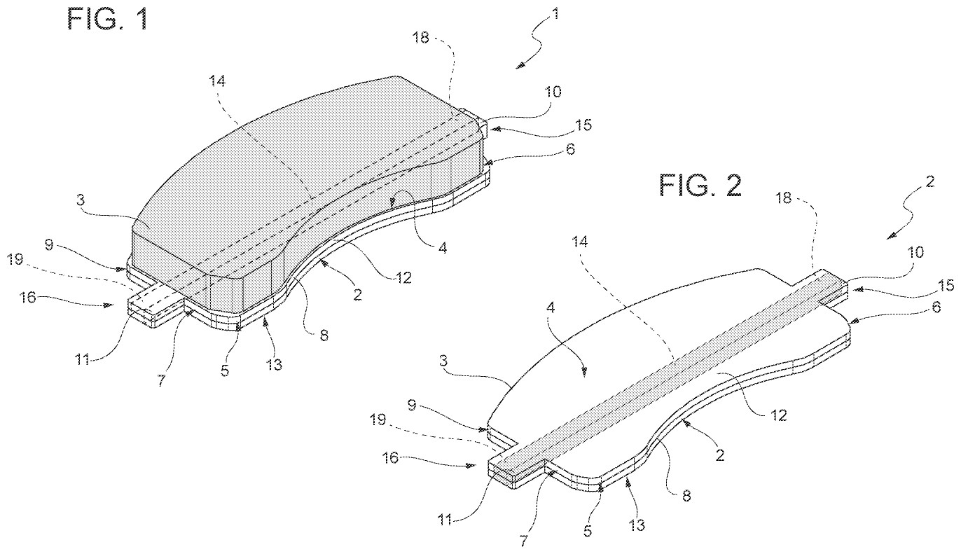

The guiding portions 10, 11 consist of/are formed in the shape of a first 15 and a second 16 ear (see FIGS. 1, 2 and 8), opposite to each other and extending cantilever from the first opposite sides 6, 7 in directions opposite to each other and substantially parallel to the second opposite sides 8, 9.

The metal (steel) bar 14 is shaped so as to have two opposite flat ends 18, 19, each embedded within one of the ear 15, 16, respectively the end 18 within the ear 15 and the end 19 within the ear 16, for the majority (namely for more than 50%) of the width thereof, measured perpendicular to the second opposite sides 8, 9.

With reference now to FIGS. from 3 to 6, the present invention also relates to a method for manufacturing a backplate, like the backplate 2 already described, configured to receive a block of friction material 3 to obtain a braking element consisting of a brake pad for vehicles, in particular for electric or hybrid vehicles, like the brake pad 1 described above.

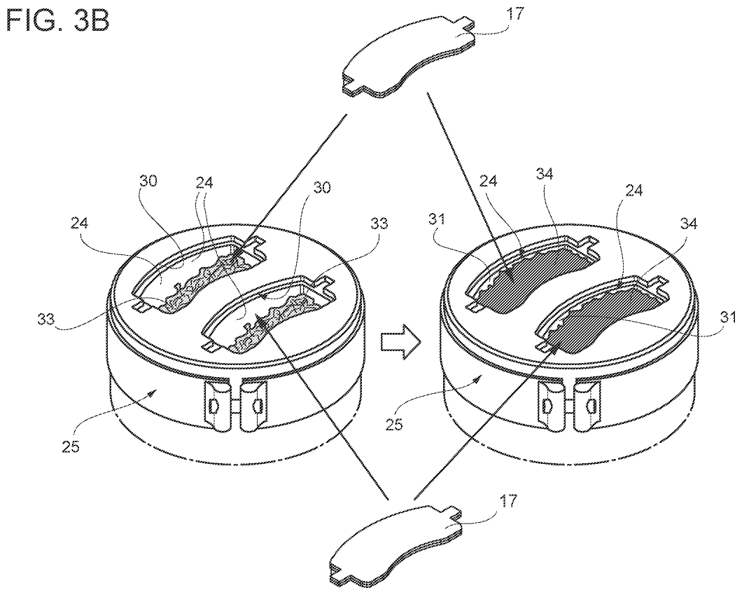

The method of the invention comprises the following steps (see in particular FIGS. 3, 4 and 5).

Firstly, it is provided at least a first and a second sheet, respectively 20, 21, of a SMC (sheet molding compound) or BMC cut in the shape of a perimetral profile of the backplate 2 to be produced, namely, in the case in point, cut in the shape of the perimetral edge 5.

Each first 20 and second 21 SMC/BMC sheet comprise a respective first 22 and second 23 opposite transversal peripheral portions thereof configured to obtain the respective guiding portions 10, 11 of the backplate 2 to be produced when the corresponding first and second transversal peripheral portions 22, 23 of the first and second SMC sheets 20, 21 are stacked onto each other and joined to each other integral in one piece.

Secondly, it is provided a reinforcing metal core 14 consisting in a metal bar, preferably made of steel, having opposite flat ends 18, 19, each configured to be sandwiched between a corresponding couple of first or second transversal peripheral portions 22 or 23 of the first and second SMC sheets 20, 21, namely the end 18 between the corresponding peripheral portions 22 of the SMC sheets 20, 21 and the end 19 between the corresponding peripheral portions 23 of the same SMC sheets 20, 21.

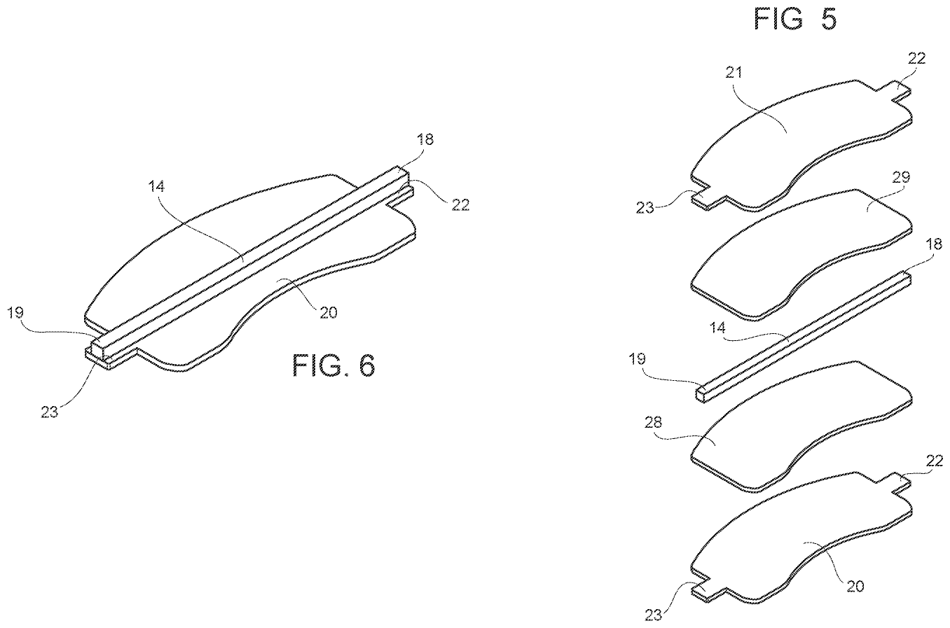

Thirdly, the first and second SMC sheets 20, 21 and the metal bar/core 14 are assembled together, stacked onto each other, as shown schematically in FIGS. 3A and 5, to form a blank 17 (FIG. 3A), which is then arranged within a cavity 24 of a mold 25 (see FIGS. 3A and 3B). Cavity 24 is configured to reproduce in negative the shape of the backplate 2 (and not only that one, as it will be seen) to be obtained.

When forming the blank 17, the bar 14 is stacked (FIG. 6) onto the first SMC sheet 20 and with its opposite flat ends 18, 19 resting on the first and second transversal peripheral portions 22, 23, respectively, of the first SMC sheet 20.

Thereafter, the second SMC sheet 21 (FIGS. 3A and 5) is arranged upon the first one and the metal bar 14, having care of following the perimetral profile of the first SMC sheet 20 and so as to sandwich the metal (steel) bar 14 between the first and second SMC sheet 20, 21.

After insertion of the blank 17 within mold 25, the mold 25 is closed and it is applied to its content, simultaneously, a pressure P and sufficient heat to bring the first and second SMC sheet 20, 21 to a prefixed temperature and under a prefixed pressure so as to join integral in one piece the SMC sheet 20, 21 to each other to form a SMC substrate 12 within which the metal bar 14 is completely embedded, so forming a backplate 2 according to the invention.

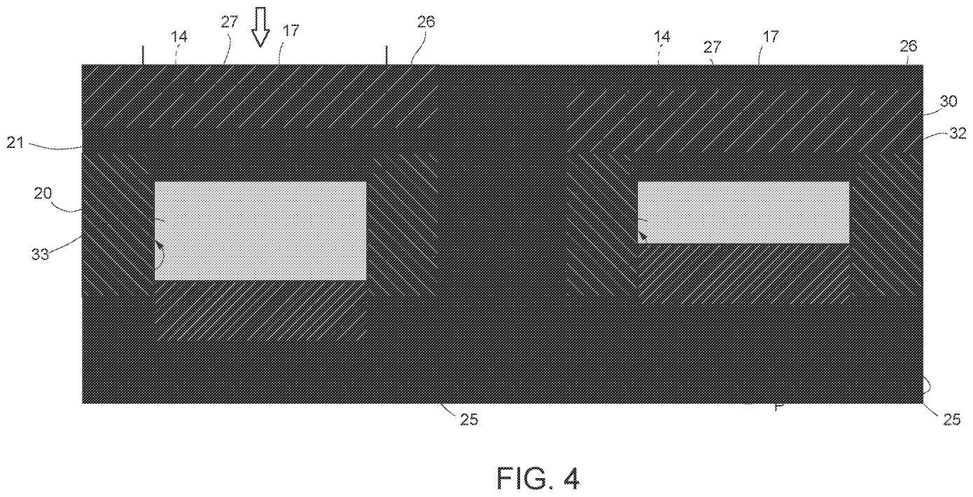

The whole process is also schematized in a purely pictorial way in FIG. 4. The cavity 24 is open upwards so as to be accessible from the top thereof and may be closed by a cover (or piston or plate) 26, which is an integral part of the mold 25 and which may be configured to apply heat to the content of cavity 24. The heat is schematized as an electric resistance 27, but any different way of heating may be also used. To apply the required pressure P, indicate by an arrow, the mold 25 may be equipped with a slidable piston 35, which also form the bottom wall of cavity 24.

As already mentioned, the first and second SMC sheet 20, 21 to be used according to the method of the invention are made in a pre-cured thermosetting polymer, in which chopped long strand mineral fibers are embedded, possibly with the further addition of mineral fillers, as already indicated above.

Accordingly, the pre-cured thermosetting polymer is chosen in the group consisting of vinyl ester resin, phenolic based SMC/BMC resin and epoxy SMC resin, the latter resin being added with a flame retardant; and the chopped long strand mineral fibers are chosen in the group consisting of carbon fibers, glass fibers, mixtures thereof.

Preferably, it is moreover used a metal bar 14 which is straight preferably, but not exclusively, has a substantially rectangular cross-section.

The method of the invention is most preferably carried out by using a pre-cured thermosetting polymer consisting,
either of an epoxy resin containing about 55% by weight of long carbon fibers or about 60% by weight of long glass fibers,
or of a vinyl ester resin containing about 60% by weight of long carbon fibers.

The curing of the SMC (or BMC) sheets 20, 21 to obtain a monolithic backplate 2 is preferably carried out at a temperature comprised between about 50° C. and 130° C., and at a pressure comprised between 10 and 20 MPa, for a time of the order of about 1 minute for each 0.5 mm of the final thickness of the backplate 2 to be obtained.

Most preferably, the method of the invention also comprises the step of providing, together with the first and second SMC sheets 20, 21, also a third and a fourth sheet of a SMC/BMC (sheet molding compound/bulk molding compound), shown in FIGS. 3A and 5 and bearing the reference number 28 and 29, respectively.

The SMC material of which the sheets 28, 29 are made may be the same of the sheets 20, 21 or different, remaining however in the choice of SMC/BMC materials already indicate above.

According to a preferred embodiment of the invention and as shown in a non-limiting manner in the figures, the SMC sheets 28, 29 may be also cut in the shape of the perimetral profile of the backplate 2 to be produced (namely according to the profile of the perimetral edge 5, but do not comprise cantilevering transversal portions like the first and second opposite transversal peripheral portions 22, 23 of the first and second SMC sheets 20, 21.

In this preferred case, therefore, backplate 2 is formed arranging the SMC sheets 20, 21, 28, 29 and the metal (steel) bar 14 stacked upon one another, strictly following the sequence indicated herein below and schematically represented in FIG. 5:
firstly, it is arranged the first SMC sheet 20;
secondly, it is arranged the third SMC sheet 28 applied directly upon the SMC sheet 20, but leaving free therefrom the transversal peripheral portions 22, 23 of the SMC sheet 20;
thirdly, it is arranged the metal bar 14 stacked on the third SMC sheet 28 but having its opposite flat ends 18, 19 resting upon the transversal peripheral portions 22, 23 of the first SMC sheet 20;
fourthly, it is arranged the fourth SMC sheet 29, applying it in direct contact with the metal bar 14 and with the third SMC sheet 28, however solely in the whole area of the SMC sheet 28 not already occupied by the metal bar 14;
fifthly, it is arranged the second SMC sheet 21 stacked on the fourth SMC sheet 29 in direct contact thereof, having care of arranging the transversal peripheral portions 22, 23 of the SMC sheet 21 stacked onto the corresponding transversal peripheral portions 22, 23 of the first SMC sheet 20 and with the opposite flat ends 18, 19 of the metal bar 14 sandwiched between corresponding transversal peripheral portions 22, 23 of the first and second SMC sheet 20, 21.

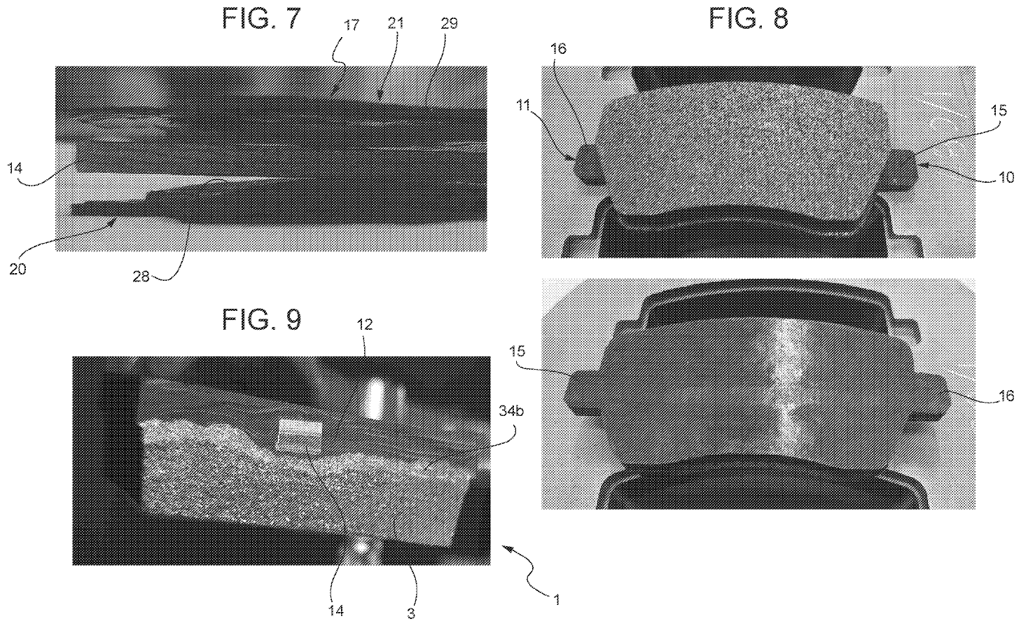

At this point, a multi-layer blank 17 (see FIGS. 3A, 4, 5 and the picture in FIG. 7) is therefore formed by the superimposed SMC sheets 20, 21, 28, 29 and by the metal core 14, which is sandwiched between at least two, in the example shown four, opposite SMC sheets.

Such a blank 17 is then arranged within cavity 24 of the mold 25, as shown in FIG. 4.

Of course, it is not excluded the possibility to insert, following the same sequence as above, the SMC sheets 20, 21, 28, 29 and the metal (steel) bar 14 directly within the cavity 24, so forming the blank 17 directly inside the mold 25.

Thereafter, in any case, the mold 25 is closed, pressure and heat are applied to the whole content thereof in order to reach the temperatures and pressures already indicated previously (FIG. 4, right hand side) and therefore cure and consolidate the whole blank 17. Then the mold 25 is opened and from cavity 24 a whole and monolithic composite backplate 2 may be extracted.

The method described above may be used with minor modification, according to a further aspect of the invention, to obtain the whole brake pad 1 in one single operation, by co-molding together the backplate 2 and the friction material block 3, starting from the raw component materials thereof.

Accordingly, the present invention also relates to a method for manufacturing a braking element consisting of a brake pad for vehicles, in particular for electric or hybrid vehicles, like the brake pad 1, wherein the brake pad 1 comprises a flat support or backplate 2 and a block of friction material 3 attached to a first face 4 of the backplate 2.

The method of the invention comprises in this case the following steps (see in particular FIGS. 3B and 5).

Firstly, it is provided a mold 25 having a cavity 24 therein reproducing in negative the shape of the whole brake pad 1 to be obtained, instead of the sole backplate 2.

The cavity 24 has in fact an inlet opening 30 oriented upwards (see left hand part of FIG. 3B and of FIG. 4), which is closed, when the mold 25 is closed, by the cover/plate 26.

The cavity 24 moreover comprises a bottom portion 31 and an upper portion 32 (see in particular, FIG. 4) having different functions.

The bottom portion 31 is opposite to the inlet opening 30 and reproduces in negative the shape of the friction material block 3 of the brake pad 1 to be obtained. It is moreover delimited at the bottom thereof by the movable (slidable) piston 35.

The upper portion 32 is arranged between the inlet opening 30 and the bottom portion 31 and reproduces in negative the shape of the backplate 2 of the brake pad 1 to be produced. The upper and bottom portions 31, 32 of the cavity 24 are in full communication with each other along the whole cross-section thereof.

Secondly, it is provided a first and a second sheet of a SMC (sheet molding compound) 20, 21 cut in the shape of a perimetral profile of the backplate 2 of the brake pad 1 to be produced, corresponding to the profile of the perimetric edge 5. Accordingly, each first and second SMC sheet 20,21 comprises a respective first and second opposite transversal peripheral portions 22,23 cut so as to follow the perimetric profile of the guiding portions 10, 11 and configured to obtain such respective guiding portions 10, 11 of the backplate 2, when the corresponding first and second transversal peripheral portions 22, 23 of the first and second SMC sheets 20, 21 are stacked onto each other, as previously described for the manufacturing method of the sole backplate 2.

Thirdly, it is provided the reinforcing metal core consisting in the metal bar 14, preferably made of steel and having opposite flat ends 18,19, each configured to be sandwiched between a corresponding couple of first 22, or second 23 transversal peripheral portions of the first and second SMC sheets 20, 21.

Fourthly, it is introduced in cavity 24 and specifically within the bottom portion 31 thereof, until to fill it completely, a raw friction material composition 33 (FIGS. 3B and 4, left hand side). For “raw” friction material composition it is intended a friction material mix or composition still to be cured and consolidated, also definable “green” friction material composition.

Thereafter, it is formed the blank 17 by stacking as described above the SMC sheets 20, 21, the bar 14 and eventually the SMC sheets 28, 29, when present.

This blank 17 formed by pre-cured (so potentially sticking) SMC/BMC sheets, is then introduced in cavity 24 (see FIG. 3B, left hand side) with the first SMC sheet 20 arranged in this case specifically inside the bottom part of the upper portion 32 of cavity 24, such as to be stacked directly upon the raw friction material composition 33 previously introduced in cavity 24.

Following the aforementioned last step, further steps similar to those as already described to obtain the backplate 2 are carried out.

In particular, the metal bar 14 remains so arranged within portion 32, stacked onto the first SMC sheet 20 and with its opposite flat ends 18, 19 resting on the first and second transversal peripheral portions 22, 23 of the SMC sheet 20.

Thereafter the mold 25 is closed and the required pressure and heat are applied to bring, simultaneously, both the raw friction material composition 33, and the first and second SMC sheet 20, 21 (and 28, 29 when present), to reach substantially the curing temperature and pressure of both of them at the same time, such as to mold simultaneously the raw friction material composition into a friction material block 3 and to join and mold the SMC sheets 20, 21 (and 28, 29 when present) into a monolithic substrate 12 having the metal bar 14 embedded therein.

At the same time, owing to the steps describe above, not only the first and second SMC sheet 20, 21 are joined integral in one piece to each other to form a backplate 2 comprising an SMC substrate 12 within which the metal bar 14 is completely embedded, but also the friction material block 3 and the SMC substate 12 of the backplate 2 are co-molded together in such a manner that they are rendered integral in one piece to each other.

The materials to be chosen for providing the SMC sheets 20, 21 are the same as already described: a pre-cured thermosetting polymer (preferably, vinyl ester resins based SMC/BMC, phenolic resins based SMC/BMC and epoxy resins based SMC/BMC added with a flame retardant) in which chopped long strand mineral fibers (preferably, carbon fibers, glass fibers, mixtures thereof) are embedded, possibly with the further addition of mineral fillers.

In particular, also in this case, the pre-cured thermosetting polymer may consist either of an epoxy resin containing about 55% by weight of long carbon fibers or about 60% by weight of long glass fibers, or of a vinyl ester resin containing about 60% by weight of long carbon fibers.

To obtain the simultaneous co-molding of the block 3 and of the composite backplate 2 their simultaneous curing step is to be carried out at a temperature comprised between about 50° C. and 130° C., and at a pressure comprised between 10 and 20 MPa, for a time of the order of about 1 minute for each 0.5 mm of thickness of the backplate 2 of the brake pad 1 to be obtained.

Preferably, also in this method, the backplate 2 is obtained using not only two, but at least four SMC sheets, in order to form the blank 17. Accordingly, according to a preferred embodiment of the method of the invention, the brake pad 1 is obtained providing, further the SMC sheets 20, 21, also at least two further SMC sheets 28, 29.

The additional third and fourth SMC sheets 28, 29 may be preferably cut in the shape of the perimetral profile of the backplate 2 of the brake pad 1 to be produced with the exclusion of the guiding portions 10, 11 thereof. Accordingly, the SMC sheets 28, 29 do not comprise the first and second opposite transversal peripheral portions 22,23 of the first and second SMC sheets 20, 21.

The sequence of stacking the various starting components and of the introduction thereof into cavity 24, passing through its inlet opening 30 is what follows.

Firstly, the blank 17 is formed outside mold 25, as described above and following the stacking sequence as already disclosed.

Secondly, the blank 17, which its first SMC sheet 20 is stacked on the raw friction material composition 33 already introduced in bottom portion 31 to fill it.

Thirdly, it is carried out the co-molding step as previously disclosed.

Finally, it is also possible to obtain a brake pad 1 completed with an underlayer 34b (FIG. 9) of any known composition.

In this case, before to introduce the blank 17 in cavity 24, a layer 34 (see FIG. 3B, right hand side thereof) of a known damping and insulating material configured to form an underlayer of the brake pad 1 to be obtained is arranged in the cavity 24 between the upper and bottom portion 32 and 31 thereof, directly in contact with the raw friction material composition 33 and the blank 17 with its SMC sheet 20 is then arranged in direct contact with the layer 34 on the side of the SMC sheet 20.

During the molding step, the curing temperature and pressure for the raw friction material composition 33 is chosen to cure also the layer 34 of a damping and insulating material to form an underlayer 34b of the brake pad 1 provided integral in one piece with the friction material block 3 and the backplate 2 and connecting them to each other (FIG. 9).

Finally, it is clear that the present invention also extends to a braking system comprising a member to be braked, constituted by a brake disc (known and not shown for sake of simplicity) made of a metal chosen in the group consisting of cast iron, steel, aluminum, a light alloy, and at least one braking member adapted to cooperate by friction with the member to be braked, wherein the braking member consists in a brake pad 1 as described.

Since the molding temperature and pressure for the SMC sheets, when they have the chemical composition as described before, are fully compatible with a geo-polymerization reaction, it stems from the above that, other than using as the raw friction material 33 any known organic friction mix, i.e., having as a binder a thermosetting resin like those phenol-based usually used in brake pads, it is also possible to use as the raw material 33 a friction material mix containing, as a binder, a geopolymer one or more precursor(s) of a geopolymer, e.g., of the kind disclosed in the pending European patent application EP3841311, in the name of the same Applicant.

### Exemplary Modes of Carrying Out the Teaching of the Present Disclosure

Inventive and comparative examples are reported here by way of illustration and are not intended to limit the invention.

### Example 1

Different types of commercial SMC sheets have been selected in order to carry out molding tests of a brake pad of a commercial type. Characteristics of the selected and tested materials are reported in table 1.

TABLE 1

| | | | Tensile | Tensile | Flexural | Flexural | Impact | Tg | Tg (post |
|---|---|---|---|---|---|---|---|---|---|
| PRODUCT | Density | Shrinkage | Modulus | Strength | Modulus | Strength | Charpy | (tand) | curing) |
| SERIES | g/cm³ | % | (MPa) | (MPa) | (MPa) | (MPa) | (kJ/m²) | ° C. | ° C. |

Polynt-SMCarbon ® 24

| | | | | | | | | | | |
|---|---|---|---|---|---|---|---|---|---|---|
| 3K | 50% | 1.43 | −0.10 | 31400 | 156 | 30700 | 445 | 48 | 170 | — |
| | 60% | 1.47 | −0.10 | 45500 | 215 | 43900 | 454 | 45 | 170 | — |
| 12K | 40% | 1.37 | −0.07 | 20300 | 80 | 17600 | 257 | 46 | 170 | — |
| | 50% | 1.40 | −0.09 | 25350 | 108 | 22650 | 285 | 46 | 170 | — |
| | 60% | 1.48 | −0.10 | 36600 | 160 | 30800 | 462 | 62 | 170 | — |
| 48K | 50% | 1.45 | −0.10 | 24500 | 70 | 25700 | 240 | 42 | 170 | — |

Polynt-SMCarbon ® 24 LW

| | | | | | | | | | | |
|---|---|---|---|---|---|---|---|---|---|---|
| 12K | 25% | 1.05 | −0.09 | 17800 | 80 | 11000 | 140 | — | — | — |

Polynt-SMCarbon ® 80

| | | | | | | | | | | |
|---|---|---|---|---|---|---|---|---|---|---|
| 3K | 60% | 1.51 | −0.11 | 41500 | 235 | 38500 | 525 | 60 | 150 | 150 |
| 3K/2 | 60% | 1.51 | −0.11 | 46200 | 240 | 49250 | 520 | 70 | 150 | 150 |
| 12K | 50% | 1.45 | −0.09 | 29000 | 190 | 25000 | 320 | 50 | 150 | 150 |
| | 60% | 1.48 | −0.10 | 33000 | 215 | 28000 | 450 | 90 | 150 | 150 |

For comparison, the same type of brake pad has been obtained also using the materials listed in Table 2.

TABLE 2

| | | Long fiber reinforced thermoset | | | | Conventional | Metal | |
|---|---|---|---|---|---|---|---|---|
| | | plastic molding composite | | | | material | | Steel |
| | | Glass fiber | | Carbon fiber | | Glass fiber | Aluminum | Carbon |
| Resin | | Phenol | Epoxy | Phenol | Epoxy | Phenol | Die-cast | steel |
| Specific gravity | — | 1.79 | 1.86 | 1.51 | 1.43 | 1.78 | 2.68 | 7.85 |
| Tensile strength | MPa | 180 | 119 | 151 | 145 | 140 | 310 | 690 |
| Tensile modulus | GPa | 25 | 24 | 49 | 46 | 22 | 71 | 205 |
| Yield Point | MPa | — | — | — | — | — | 150 | 490 |
| Flexural strength | MPa | 356 | 223 | 340 | 363 | 230 | — | — |
| Charpy impact | kJ/m² | 60 | 52 | 60 | 50 | 3 | 81 | 780 |
| strength | | | | | | | | |
| Specific tensile | MPa | 101 | 64 | 100 | 101 | 79 | 116 | 88 |
| strength | | | | | | | | |
| Specific tensile | GPa | 14 | 13 | 32 | 32 | 12 | 26 | 26 |
| modulus | | | | | | | | |

### Example 2

The same model of commercial brake pad is produced with the materials listed in table 1 and 2. For the innovative materials listed in table 1 a metallic core like the bar 14 has been sandwiched between the SMC sheets. The curing/molding operation is carried out at 160° C. and 200 kg/cm² for 3 minutes. The test parameters are listed in Table 3.

TABLE 3

| | |
|---|---|
| Detachment Min [kN] | 18.4 |
| Detachment Max [kN] | 20.5 |
| Cmpx RT Min [mm] | 0.204 (150) |
| Cmpx RT Med [mm] | 0.233 (180) |
| Cmpx RT Max [mm] | 0.266 (210) |

The test mold, of the type of that shown in FIG. 3, has been kept in a static over at 160° C. for 1 hour in order to be sure to completely cure the material under test.

Despite the high fiber content (50% wt) in the SMC sheet tested, it has been possible to observe for the materials listed at the fifth and the last lines of Table 1 the best molding results, showing that those two SMCs possess an optimal flowability, are able to incorporate the steel bar without any hole or defect near to the bar due to a limited material flowing.

### Example 3

A commercial brake pad having a standard steel backplate provided with shim and available on the market has been compared with identical brake pads produced with the materials selected from Table 1 (those of the fifth and last line) according to the results of Example 2.

The average results of a braking test carried out on the road are reported in table 4.

TABLE 4

Test No

| | |
|---|---|
| | Co-moluding |
| Standard − Steel | composite |

Pads:

| | | Smaller chamfer |
|---|---|---|
| | Standard chamfer | geometry |
| | geometry + Shim | Without shim |
| <Freq. | 9 | 8 |
| >Freq. | 8 | 7 |
| Wire Brush | 7 | 7 |
| Creep Groan | 5 | 5 |
| ST. Quietchen | 6 | 6 |

As it may be seen, the innovative SMC brake pad without shim (a damping foil normally fixed on a backplate face opposite to the friction material block) gives results comparable with a standard steel backplate (commercial product) with shim of equivalent dimensions and configuration. Accordingly, it is possible with the brake pad of the invention to use less performance shims or even do not use shims. Moreover, the SMC cost is lower than that of standard steel backplates with shims and about the half of the woven prepreg (product developed for aeronautical sector) actually available.

Finally, the SMC product according to the invention is compatible with the co-molding technology owing to its faster reactivity when compared e.g. with known woven prepreg, which cannot be subjected to a co-molding.

Owing to the disclosed technology, it be may hypothesized that it could be possible combining layers of SMC having different composition in terms of fibers and/or rubber-like fillers, to introduce greater damping capabilities or using a glass fiber reinforced SMC in the outermost layer (the vehicle outboard layer) of substrate 12 (e.g. the sheet 21) to better resist piston stresses of the brake caliper.

All the aims of the present disclosure are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. A braking element consisting of a brake pad (1) for vehicles adapted to equip electric or hybrid vehicles, the braking element comprising:
a plate support or backplate (2); and
a friction material block (3) provided integral onto a first face (4) of the backplate, wherein the first face is bounded by a perimetral edge (5) of the backplate
delimited by first and second opposite sides (6,7;8,9) thereof,
the first sides (6,7) is arranged transversely to the second sides (8,9), the backplate (2) is made of a composite material and is provided with
guiding portions (10,11) arranged at the opposite first sides (6,7) of the backplate, the composite material of the backplate (2) comprises:
a substrate (12) including the first face (4) and the perimetral edge (5) and a second face (13), opposite and substantially parallel to the first face, the substrate (12) being made of a fiber reinforced SMC/BMC (Sheet Molding Compound/Bulk Molding Compound); and
a reinforcing metal core (14) completely embedded in the substrate (12) and extending crosswise thereof between the first sides (6,7) and within the guiding portions (10,11), so that the guiding portions of the opposite first sides are mechanically connected to each other through the substrate (12) by the reinforcing metal core (14).

2. The braking element of claim 1, wherein the SMC/BMC (Sheet/Bulk Molding Compound) forming the substrate (12) is chosen in from a group consisting of: vinyl ester SMC/BMC, phenolic based SMC/BMC and epoxy SMC/BMC, the latter epoxy SMC/BMC added with a flame retardant.

3. The braking element of claim 1, wherein the SMC/BMC consists of a polymeric matrix in which chopped long strand fibers are embedded, the fibers being chosen in the from a group consisting of: carbon fibers, glass fibers, mixtures thereof.

4. The braking element of claim 3, wherein the polymeric matrix is added with mineral fillers.

5. The braking element according to claim 1, wherein the reinforcing metal core (14) is made of steel.

6. The braking element according to claim 1, wherein the reinforcing metal core consists in an elongated metal bar (14) extending within the guiding portions (10,11) of the opposite first sides and within the substrate (12), parallel to the first and second face (4,13) thereof.

7. The braking element of claim 6, wherein the metal bar (14) is substantially straight.

8. The braking element of claim 6, wherein the guiding portions consist of a first and a second ear (15,16), opposite to each other and extending cantilever from said first opposite sides (6,7) in directions opposite to each other and substantially parallel to the second opposite sides (8,9); the metal bar (14) having opposite flat ends (18,19), each embedded within one of the first and second ear (15,16) for the majority of the width thereof, measured perpendicular to the second opposite sides.

9. A method for manufacturing a backplate (2) configured to receive a block (3) of friction material to obtain a braking element consisting of a brake pad (1) for vehicles, in particular for electric or hybrid vehicles, the method comprising:
providing at least a first and a second sheet (20,21) of a SMC/BMC (sheet/bulk molding compound) cut in the shape of a perimetral profile of the backplate to be produced, each of the first and second SMC sheet (20,21) comprising a respective first and second opposite transversal peripheral portions (22,23) configured to obtain respective guiding portions (10,11) of the backplate (2) when the corresponding first and second transversal peripheral portions (22,23) of the first and second SMC/BMC sheets are stacked onto each other;
providing a reinforcing metal core consisting in a metal bar (14), preferably made of steel, having opposite flat ends (18,19), each configured to be sandwiched between a corresponding couple of first or second transversal peripheral portions (22,23) of the first and second SMC/BMC sheets (20,21);
stacking upon the first SMC/BMC sheet (20) the metal bar (14) with the opposite flat ends (18,19) thereof resting on the first and second transversal peripheral portions (22,23) of the first SMC/BMC sheet (20);
stacking the second SMC/BMC sheet (21) upon the metal bar (14) and the first SMC/BMC sheet (20) following the perimetral profile of the latter and so as to sandwich the metal bar (14) between the first and second SMC/BMC sheet (20,21) to form a blank (17);
arranging the blank (17) within a cavity (24) of a mold (25) reproducing in negative the shape of the backplate (2) to be obtained;
closing the mold (25) and applying simultaneously pressure and heat to bring the first and second SMC/BMC sheet (20,21) to a prefixed temperature under a prefixed pressure so as to join integral in one piece the first and second SMC/BMC sheet (20,21) to each other to form a SMC/BMC substrate (12) within which the metal bar (14) is completely embedded; wherein:
the first and second SMC/BMC sheet (20,21) are made in a pre-cured thermosetting polymer, in which chopped long strand mineral fibers are embedded, possibly with the further addition of mineral fillers.

10. The method according to claim 9, wherein the pre-cured thermosetting polymer is chosen from a group consisting of: vinyl ester resins, phenolic based resins and epoxy resins, eventually added with a flame retardant; the chopped long strand mineral fibers are chosen from a group consisting of: carbon fibers, glass fibers, mixtures thereof.

11. The method according to claim 9, wherein the metal bar is substantially straight.

12. The method according to claim 9, wherein the pre-cured thermosetting polymer consists either of: an epoxy resin containing about 55% by weight of long carbon fibers or about 60% by weight of long glass fibers; or of a vinyl ester resin containing about 60% by weight of long carbon fibers.

13. The method according to claim 9, wherein the closing the mold and applying simultaneously pressure and heat step is carried out at a temperature comprised between about 50° C. and 130° C., and at a pressure comprised between 10 and 20 MPa, for a time of the order of about 1 minute for each 0.5 mm of thickness of the backplate to be obtained.

14. The method according to claim 9, wherein
in the providing at least a first and a second sheet step it is further provided a third and a fourth sheet of a SMC/BMC (sheet/bulk molding compound) cut in the shape of the perimetral profile of the backplate to be produced but not comprising the first and second opposite transversal peripheral portions of the first and second SMC sheets; and wherein:
in the stacking upon the first SMC/BMC sheet and stacking the second SMC/BMC sheet steps the first, second, third and fourth SMC/BMC sheet and the metal bar are all stacked together to form the blank (17) in the following strict sequence:
the first SMC/BMC sheet (20);
the third SMC/BMC sheet (28) applied directly upon the first one but leaving free the transversal peripheral portions (22,23) thereof;
the metal bar (14) stacked on the third SMC/BMC sheet (28) and with the opposite flat ends (18,19) of the metal bar resting upon the transversal peripheral portions (22,23) of the first SMC/BMC sheet (20);
the fourth SMC/BMC sheet (29), in direct contact with the metal bar (14) and with the third SMC/BMC sheet (28) in a whole area thereof not occupied by the metal bar (14);
the second SMC/BMC sheet (21) stacked on the fourth SMC/BMC sheet (29) in direct contact thereof and with its transversal peripheral portions (22,23) stacked on the corresponding transversal peripheral portions of the first SMC/BMC sheet (20) with the opposite flat ends (18,19) of the metal bar (14) sandwiched between corresponding transversal peripheral portions (22,23) of the first and second SMC/BMC sheet (20,21).

15. A method for manufacturing a braking element consisting of a brake pad (1) for vehicles, in particular for electric or hybrid vehicles, the brake pad comprising a flat support or backplate (2) and a block (3) of friction material attached to a first face (4) of the backplate; the method comprising:
providing a mold (25) having a cavity (24) therein reproducing in negative the shape of the brake pad to be obtained, the cavity (24) having an inlet opening (30) upwards, which is closed when the mold (25) is closed, and having a bottom portion (31), opposite the inlet opening (30), reproducing in negative the shape of the friction material block (3) of the brake pad (1) to be obtained;
providing at least a first and a second sheet (20,21) of a SMC/BMC (sheet/bulk molding compound) cut in the shape of a perimetral profile of the backplate (2) of the brake pad to be produced, each of the first and second SMC/BMC sheet (20,21) comprising a respective first and second opposite transversal peripheral portions (22,23) configured to obtain respective guiding portions (10,11) of the backplate (2) when the corresponding first and second transversal peripheral portions of the first and second SMC/BMC sheets are stacked onto each other;
providing a reinforcing metal core (14) consisting in a metal bar, preferably made of steel, having opposite flat ends (18,19), each configured to be sandwiched between a corresponding couple of first or second transversal peripheral portions (22,23) of the first and second SMC/BMC sheets;
introducing in the cavity (24), within the bottom portion (31) thereof, a raw friction material composition (33);
arranging onto the first SMC/BMC sheet (20) the metal bar (14) stacking it onto the first SMC/BMC sheet (20) with its opposite flat ends (18,19) resting on the first and second transversal peripheral portions (22,23) of the first SMC/BMC sheet (20);
stacking the second SMC/BMC sheet (21) upon the metal bar (14) and the first SMC/BMC sheet (20) following the perimetral profile of the latter, so as to sandwich the metal bar (14) between the first and second SMC/BMC sheet (20,21) to form a blank (17);
arranging said blank (17) within an upper portion (32) of said cavity (24) arranged between the inlet opening (30) and the bottom portion (31) and reproducing in negative the shape of the backplate (2) of the brake pad (1) to be produced, the upper and bottom portion (32,31) of the cavity being in full communication with each other, the first SMC/BMC sheet (20) being stacked upon the raw friction material composition (33);
closing the mold and applying simultaneously pressure and heat to bring the raw friction material composition (33), and substantially the first and second SMC/BMC sheet (20,21) too, to a curing temperature and pressure for the raw friction material composition (33) such as to mold the latter into the friction material block (3) and simultaneously join integral in one piece the first and second SMC/BMC sheet (20,21) to each other to form a backplate (2) comprising an SMC/BMC substrate (12) within which the metal bar (14) is completely embedded, the temperature and pressure being such as to also co-mold the friction material block (3) and the SMC/BMC substrate (12) of the backplate together, to render them integral in one piece to each other; wherein:
the first and second SMC/BMC sheet (2021) are made in a pre-cured thermosetting polymer in which chopped long strand mineral fibers are embedded, possibly with the further addition of mineral fillers.

16. The method of claim 15, wherein the pre-cured thermosetting polymer is chosen from a group consisting of: vinyl ester resins, phenolic based resins and epoxy resins added with a flame retardant; the chopped long strand mineral fibers being chosen from a group consisting of: carbon fibers, glass fibers, mixtures thereof.

17. The method according to claim 15, wherein the metal bar is substantially straight.

18. The method according to claim 15, wherein the pre-cured thermosetting polymer consists either of: an epoxy resin containing about 55% by weight of long carbon fibers or about 60% by weight of long glass fibers; or of a vinyl ester resin containing about 60% by weight of long carbon fibers.

19. The method according to claim 15, wherein the closing the mold and applying simultaneously pressure and heat step is carried out at a temperature comprised between about 50° C. and 130° C., and at a pressure comprised between 10 and 20 MPa, for a time of the order of about 1 minute for each 0.5 mm of thickness of the backplate of the brake pad to be obtained.

20. The method according to claim 15, wherein:
in the providing at least a first and a second sheet step a third and a fourth sheet (28,29) of a SMC/BMC (sheet/bulk molding compound) are further provided, the third and fourth SMC/BMC sheets (28,29) being cut in the shape of the perimetral profile of the backplate (2) of the brake pad to be produced but not comprising the first and second opposite transversal peripheral portions (22,23) of the first and second SMC sheets; and
in the arranging onto the first SMC/BMC sheet and stacking the second SMC/BMC sheet steps the first, second, third and fourth SMC/BMC sheet (20,21,28,29) and the metal bar (14) are stacked onto each other so as to form the blank (17) according to the following strict sequence:
the first SMC/BMC sheet (20);
the third SMC/BMC sheet (28) applied directly upon the first SMC/BMC sheet (20), but leaving free the transversal peripheral portions (22,23) thereof;
the metal bar (14) stacked on the third SMC/BMC sheet (28) and with the opposite flat ends (18,19) of the metal bar resting upon the transversal peripheral portions (22,23) of the first SMC/BMC sheet (20);
the fourth SMC/BMC sheet (29), in direct contact with the metal bar (14) and with the third SMC/BMC sheet (28) in a whole area thereof not occupied by the metal bar;
the second SMC/BMC sheet (21) stacked on the fourth SMC/BMC sheet (29) in direct contact thereof and with its transversal peripheral portions (22,23) stacked on the corresponding transversal peripheral portions of the first SMC/BMC sheet (20) with the opposite flat ends of the metal bar (14) sandwiched between corresponding transversal peripheral portions (22,23) of the first and second SMC/BMC sheet (20,21).

21. The method according to claim 15, wherein
before carrying out the arranging the blank step, a layer (34) of a damping and insulating material configured to form an underlayer of the brake pad (1) to be obtained is arranged in the cavity (24) between the upper and bottom portion (32,31) thereof, directly in contact with the raw friction material composition (33);
in the arranging the blank step the blank (17) is arranged with the first SMC/BMC sheet (20) in direct contact with the layer (34) of a damping and insulating material; and
the curing temperature and pressure for the raw friction material composition (33) being chosen to cure also the layer (34) of a damping and insulating material to form an underlayer (34b) of the brake pad (1) provided integral in one piece with the friction material block (3) and the backplate (2) and connecting them to each other.

22. (canceled)
